(19) United States
(12) Patent Application Publication
(10) Pub. No.: US 2009/0206152 A1
(43) Pub. Date: Aug. 20, 2009

(54) Check Scanning Apparatus and Methods

(76) Inventors: Glenn R. Embury, Fontana, CA (US); Philip G. Barboni, Upland, CA (US)

Correspondence Address: COOK ALEX LTD, SUITE 2850, 200 WEST ADAMS STREET, CHICAGO, IL, 60606, US

(21) Appl. No.: 12/033,598

(22) Filed: Feb. 19, 2008

(51) Int. Cl. G06F 17/00

(52) U.S. Cl. 235/375

(57) ABSTRACT

A check scanner endorses or cancels a check with a print head when the check is driven in the forward direction, and franks, endorses or prints again when the check is driven in the reverse direction. Two separate images of each side of the check are generated for digital comparison and verification purposes by scans with contact image sensors (CIS), with one image from scanning in the forward direction and another image from scanning in the reverse direction. A high resolution image may be obtained by CIS scanning when the check is driven in the forward direction and an even higher resolution image may be obtained by CIS scanning when the check is driven in the reverse direction. Alternately, a grey scale image may be obtained by CIS scanning when the check is driven in the forward direction, and a color image may be obtained by CIS scanning when the check is driven in the reverse direction. After scanning, the check is returned back to the original point of entry.

### FIELD OF THE INVENTION

The present invention relates generally to improved methods and apparatus for scanning of checks.

### BACKGROUND OF THE INVENTION

Check scanners are utilized in most banks and also in corporate offices, and many retail and service establishments. Traditional check scanners utilize a horseshoe or U-shaped passage for scanning of a check with a first input end into which the check is inserted. The check is then moved in a single direction through the passage by a drive mechanism. When the check reaches the second output end of the passage, it is typically collected in an output tray.

Positioned along the passage is a magnetic head for reading the special characters imprinted with magnetic ink, usually along a bottom edge of the check. This process is known in the art as magnetic ink character recognition, or by the acronym MICR. The MICR reading head is typically small since it only needs to read the bottom portion of the check which has the magnetic ink information. The magnetic ink information typically printed on the checks includes a bank routing number, a bank account number and a check number. Occasionally, the check scanner may be unable to reliably read this MICR information and the check may have to be inserted into the check scanner one or more times to attempt a successful magnetic read of the check, or else the data must be keyed manually.

In addition to the MICR reading head, more recent check scanners may also utilize contact image sensor (CIS) scanning heads to obtain grey scale or color images of the entire front and back sides of a check. Banks, for example, use these images to post canceled checks on the bank's internet site. A bank customer may then view and print images of canceled checks associated with his/her bank account. Prior CIS check scanning heads typically have about 200 dots per inch (DPI) capability or resolution.

Prior art check scanners also suffer from relatively high manufacturing and assembly costs. For example, many of the internal components, such as the CIS scanning heads, the MICR reader, the printer head assembly, the transport rollers, sensors and the like, are typically separately mounted onto the base plate of the check scanner, which is time consuming and costly due to the positional accuracy requirements of these components to the associated 90 degree scanning plane.

A general object of the present invention is to therefore provide improved apparatus and methods for the scanning of checks.

Another object of the present invention is to endorse a check by means of a printer when the check is driven in the forward direction in a check scanner, and then frank or cancel the check when it is driven in the reverse direction.

A further object of the present invention is to generate two separate and distinct images of each side of the same check for digital comparison and verification purposes, such as a first image of each side from a forward direction scan and a different second image from a reverse direction scan.

Yet another object of the present invention is to capture a high resolution image when the check is driven in the forward direction and to capture an even higher resolution image when the check is driven in the reverse direction, or vice versa.

A further object of the present invention is to capture a grey scale image when the check is driven in the forward direction and to capture a color image when the check is driven in the reverse direction, or vice versa.

A still further object of the present invention is to return the check, after scanning, backwards out of the passage into which it was inserted to the original entry position.

Another object of the present invention is to mount many of the components of the check scanner transport mechanism onto the pair of vertical parallel walls which define the transport path for the check prior to assembly of the walls onto the base plate.

Yet another object of the present invention is to provide methods for efficient assembly of a check scanner where many of the components snap into the pair of walls, and the pair of walls likewise snap into the base plate.

### SUMMARY OF THE INVENTION

The present invention is directed to a check scanner which includes the features of endorsing the check with a print head when the check is driven in the forward direction so that the endorsement becomes part of the scanned image file, and then endorsing again (or franking or canceling or printing other processing information) on the check while it is being driven in the reverse direction to provide visual indication that the check has been scanned. Two separate images of each side of the check may be generated via contact image sensor (CIS) scanning of the same document for digital comparison and verification from the first scanned image obtained from the forward direction scan and from a second scanned image obtained from the reverse direction scan. For example, a high resolution image is obtained via CIS scanning when the check is driven in the forward direction and an even higher resolution image is obtained via CIS scanning when the check is driven in the reverse direction, or vice versa. Alternately, a gray scale image could be obtained via CIS scanning when the check is driven in the forward direction and a color image could be obtained via CIS scanning when the check is driven in the reverse direction, or vice versa. After scanning, the check is returned backwards out of the path into which it was inserted to the original point of entry. A manually positioned output collection tray mechanically activates a diverter gate positioned along the path to provide a scan and return mode where the check is returned to the inlet port, or to provide a pass-through mode of scanning where the check is ejected out of the end of the scanner into the tray. A feature on the collection tray interrupts a sensor when the tray is in the pass-through mode, such sensor provides the appropriate control for each mode.

A check scanner for scanning a check may include a pair of spaced-apart vertical parallel walls, with the spaced-apart walls defining a path there-between. The path has an inlet port in communication with the path for inserting the check into the scanner and an end of the path. A drive system moves the check along the path in a forward direction. A sensor determines when the check has reached the end of the path, and the drive system then reverses the direction of movement of the check and moves the check along the path in a reverse direction to return the check to the inlet port.

The check scanner may further include a printer disposed along the path for printing information on the check when the check passes the printer in the forward direction and/or when the check passes the printer in the reverse direction. A pair of contact image sensors is disposed on opposite sides of the path, for scanning both sides of the check when the check passes the pair of contact image sensors in the forward direction and again when the check passes the contact image sensors in the reverse direction to provide two distinct scans of each side of the check. Preferably, the pair of contact image sensors has a resolution of at least 300 dots per inch to provide a higher resolution grey scale image of both sides of the check when the check is scanned in one direction and also the ability to provide a color image of both sides of the check when the check is scanned in the opposite direction. The check scanner includes a magnetic ink character recognition (MICR) reader disposed along the path for reading information printed on the check when the check passes the magnetic ink character recognition reader in the forward direction and again when the check passes the magnetic ink character recognition reader in the reverse direction.

The check scanner may also include a diverter gate disposed along the path, which is moveable between a first position in which the check is moved along the path in forward and reverse directions to return the check to the inlet port, and the diverter gate moveable to a second position in which the check is moved in the forward direction and the check is discharged at the end of the check scanner. When the diverter gate is in the second position, the path may be generally linear. When the diverter gate is in the first position, the path may be generally U-shaped, with one of the legs of the U-shaped path being truncated. The truncated leg of the U-shaped path provides an internal holding bin for the check as the check reaches the end of the path.

In an embodiment, one of the spaced-apart walls may terminate before the end of the path and a portion of the top cover of the check scanner provides a wall for that portion of path.

In another embodiment, the present invention also reads the MICR information at different gain settings to optimize the accuracy of the reading. An analog amplifier receives a magnetic ink character information signal from the magnetic ink character recognition reader, a digital processor determines the magnitude of the magnetic ink character information signal from a first reading of the magnetic ink character information on the check, and a digital potentiometer adjusts the gain of the analog amplifier in accordance with the determination of the magnitude of the magnetic ink character information signal before a second or redundant reading of the magnetic ink character information on the check. The digital potentiometer is coupled to the analog amplifier and receives a control signal from the digital processor to adjust the gain of the analog amplifier.

The present invention is further directed to methods of scanning checks. Exemplary methods include the steps of endorsing the check with the print head when the check is driven in the forward direction, and then endorsing again (or franking or canceling or printing other processing information) on the check while it is being driven in the reverse direction, generating separate images of each side of the check with a pair of CIS scanning heads for digital comparison and verification with scanned images obtained from the forward direction scan and from the reverse direction scan, capturing of a high resolution image with the CIS scanning heads when the check is driven in the forward direction and capturing of an even higher resolution image with the CIS scanning heads when the check is driven in the reverse direction, capturing a grey scale image when the check is driven in the forward direction and capturing a color image when the check is driven in the reverse direction, and returning the check, after scanning, backwards out of the path into which it was inserted to the original point of entry.

Representative steps of such scanning methods may include providing a pair of spaced-apart walls 204 and 206 with a path between the spaced-apart walls from an inlet port to an end, moving the check along the path in a forward direction, determining when the check has reached the end of the path, reversing the direction of movement of the check when it is determined that the check has reached the end of the path, and moving the check along the path in a reverse direction to return the check to the inlet port. The step of determining when the check has reached the end of the path may be determined by a sensor.

Further steps of the methods may include disposing a printer along the path, printing information on the check when the check passes the printer in the forward direction, and printing information on the check when the check passes the printer in the reverse direction. Other steps include disposing a pair of contact image sensors on opposite sides of the path, scanning both sides of the check with the pair of contact image sensors when the check passes in the forward direction, and scanning both sides of the check with the pair of contact image sensors when the check passes in the reverse direction. Additional steps may include providing the pair of contact image sensors with a resolution of at least 300 dots per inch, obtaining a grey scale image of both sides of the check when the check is scanned in one direction, and obtaining a color image of both sides of the check when the check is scanned in the opposite direction. Further steps may include disposing a magnetic ink character recognition reader 226 disposed along the path, reading information printed on the check when the check passes the magnetic ink character recognition reader in the forward direction, and reading information printed on the check when the check passes the magnetic ink character recognition reader in the reverse direction.

In another embodiment, steps of the methods may include disposing a diverter gate 236 along the path, positioning the diverter gate moveable to a first position in which the check is moved along the path in forward and reverse directions to return the check to the inlet port 104, and positioning the diverter gate to a second position in which the check is moved in the forward direction and the check is discharged at the end of the check scanner. Other steps may include providing a generally linear path when the diverter gate is in the second position, providing a generally U-shaped path when the diverter gate is in the first position, with one of the legs of the U-shaped path being truncated, and providing an internal holding bin at the truncated leg of the U-shaped path for the check as it reaches when the check when it reaches the end of the path.

The methods may further include the steps of providing a top cover for the check scanner, terminating one of the spaced-apart walls before the end of the path; and using a portion of the top cover to provide a wall for that portion of path which extends beyond the spaced-apart wall which terminates before the end of the path.

A further embodiment of the present invention is concerned with methods of reading the MICR information at different gain settings to optimize the accuracy of the reading. A method may include the steps of reading the magnetic character information on the check with a magnetic character information reader, providing a magnetic ink character information signal from the magnetic character information reader to an analog amplifier, determining the magnitude of the magnetic ink character information signal after a first reading of the magnetic ink character information on the check, and adjusting the gain of the analog amplifier in accordance with the determination of the magnitude of the magnetic ink character information signal before further readings of the magnetic ink character information on the check. Further method steps may include performing the step of determining the magnitude of the magnetic ink character information signal with a digital processor, coupling a digital potentiometer to the analog amplifier for controlling the gain of the analog amplifier, receiving a control signal at the digital potentiometer from the digital processor, said control signal related to the determination of the magnitude of the magnetic ink character information signal, and adjusting the gain of the analog amplifier with the digital potentiometer.

An embodiment of the present invention is directed to a subassembly for a check scanner including a base plate, the base plate having a top side and a bottom side with a plurality of apertures extending between the top side and the bottom side, a pair of parallel spaced-apart walls, the spaced-apart walls defining a path between the walls for routing of the check in the check scanner, the spaced-apart walls having a plurality of downwardly extending securing pegs, the pair of spaced-apart walls assembled onto the top side of the base plate when plurality of downwardly extending securing pegs are inserted into the plurality of apertures in the base plate, and a printed circuit board having a plurality of apertures arranged to receive at least some of the securing pegs of the pair of spaced-apart walls such that the printed circuit board is located and secured to the securing pegs adjacent to the bottom surface of the base plate.

Another embodiment of the present invention is concerned with a check scanner including a base plate, a pair of spaced-apart walls attached to said base plate, the spaced-apart walls defining a path between the walls for routing of said check in the check scanner, a pair of contact image sensor heads attached to the walls for obtaining images of the check, a magnetic ink character recognition reader attached to one of the walls to read information from the face of the check, and a print head attached to one of the walls for printing information on the check, whereby the pair of spaced apart walls may be easily assembled onto the base with the pair of contact image sensor heads, the magnetic ink character recognition reader and the printer head preassembled onto the pair of spaced-apart walls.

Other components which may be preassembled onto one or more walls prior to assembling of the walls onto the base include a plurality of transport rollers, a plurality of pressure rollers, a contact image sensor door, a holding bin door and a diverter gate.

Another embodiment of the present invention is directed to methods of assembling a check scanner including the steps of providing a base plate, providing a pair of spaced-apart walls for routing of said check in the check scanner, preassembling a pair of contact image sensor heads to the walls for obtaining images of the check, preassembling a magnetic ink character recognition reader to one of the walls to read information from the check, and assembling the pair of spaced apart walls onto the base plate after the contact image sensor heads and the magnetic ink character recognition reader have been preassembled onto the pair of spaced apart walls.

The methods may include the further steps of preassembling a plurality of transport rollers onto at least one of the pair of spaced apart walls prior to the pair of spaced apart walls being assembled onto said base plate, preassembling a plurality of pressure rollers onto at least one of the pair of spaced apart walls prior to the pair of spaced apart walls being assembled onto said base plate, preassembling a contact image sensor door onto one of the pair of spaced apart walls prior to the pair of spaced apart walls being assembled onto said base plate, preassembling a holding bin door onto one of the pair of spaced apart walls prior to the pair of spaced apart walls being assembled onto said base plate, and/or preassembling a diverter gate onto one of the pair of spaced apart walls prior to the pair of spaced apart walls being assembled onto said base plate.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1 is a perspective view of a check scanning device in accordance with the present invention;

FIG. 2 is a top plan view of the check scanning device of FIG. 1 with a top cover removed to illustrate the interior construction thereof;

FIG. 3 is a top plan view of the check scanning device of FIGS. 1 and 2 with a leading edge of a check inserted into the scanning path;

FIG. 4 is a top plan view of the check scanning device of FIG. 1 with the check transported further along the scanning path than in FIG. 3;

FIG. 5 is top plan view of the check scanning device of FIG. 1 with the check fully transported into the scanning path as compared to FIG. 4;

FIG. 6 is a top plan view of the check scanning device of FIG. 1 with the check transported further along the scanning path than in FIG. 5, with the leading edge of the check past the first end of a diverter;

FIG. 7 is a top plan view of the check scanning device of FIG. 1 with the check near the end of the scanning path where the direction of drive of the check will reverse to return the check out of the scanning path into which it was initially inserted;

FIG. 8 is a top plan view of the check scanning device of FIG. 1 with a diverter in a different position than shown in FIGS. 2-7 such that the check is routed through the scanning path and is ejected out of the back end of the check scanner;

FIG. 9 is an elevation detail view of a portion of one wall illustrating the use of the walls to support various components;

FIG. 10 is an elevation detail view of a portion of both walls near the holding bin area shown in FIGS. 2-8, also illustrating the use of the walls to support various components;

FIG. 11 is a perspective view of the walls further illustrating the construction and details thereof; and

FIG. 12 is a circuit diagram of an adaptive MICR reading circuit which adjusts the circuit gain while making redundant reads of the MICR information on a check.

### DESCRIPTION OF THE PREFERRED EMBODIMENTS

It will be understood that the present invention may be embodied in other specific forms without departing from the spirit thereof. The present examples and embodiments, therefore, are to be considered in all respects as illustrative and not restrictive, and the invention is not to be limited to the details presented herein.

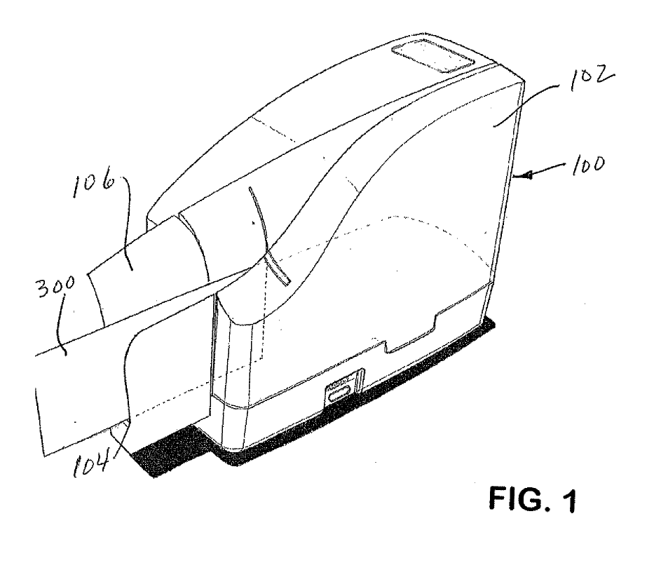

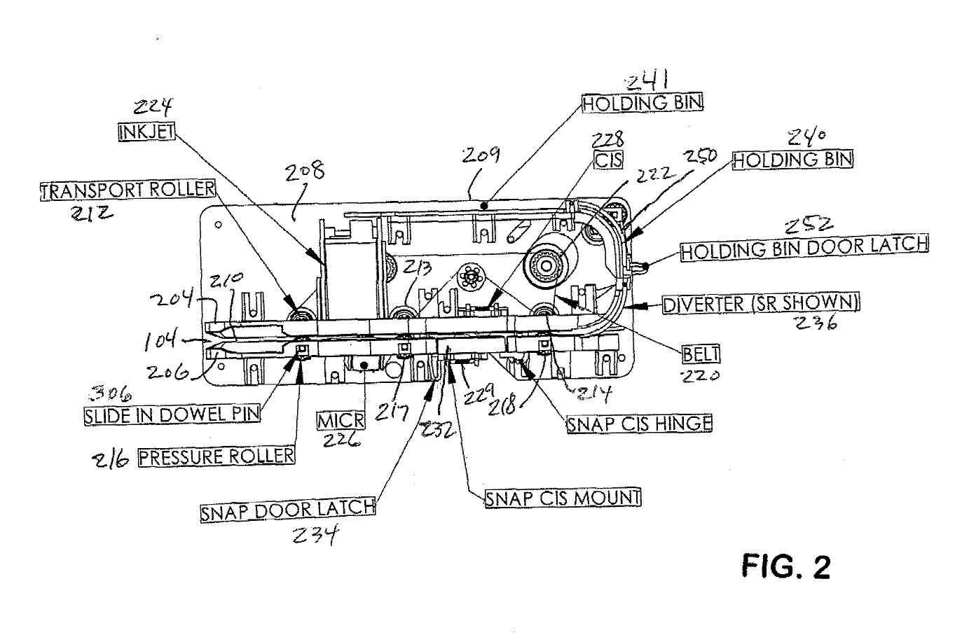

FIG. 1 illustrates a check scanning device 100. Check scanning device 100 may alternatively be described herein as a check scanner, or the like. Check scanner 100 is particularly suited for scanning and imprinting checks, such as check 300. However, the various aspects of the present invention may be utilized in the scanning or processing of other types of documents. Scanner 100 preferably has a removable top cover 102. For example, cover 102 can be removed to service or inspect the internal components of scanner 100, such as to replace an ink cartridge or the like. Checks to be scanned are inserted into a generally vertically disposed slot 104. Slot 104 is the opening to an internal scanning path 210, as seen in FIGS. 2-8.

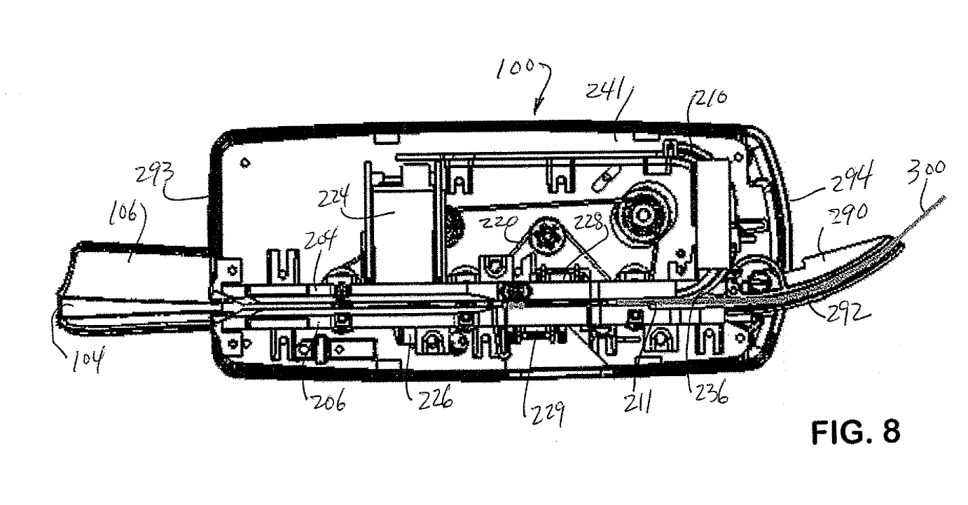

When the cover 102 is removed from the scanner 100, the internal construction and the arrangement of the internal components of the scanner can be seen, such as illustrated in FIG. 2. A pair of spaced-apart and generally vertically disposed walls 204 and 206 defines a path 210 there-between. A check to be scanned is routed along the path 210 between walls 204 and 206. The walls 204 and 206 are attached to, and supported by, a base plate 208. Preferably, scanner 100 includes an extension 106 at front wall 293 (see also FIG. 8) for better support of the check 300 as it is inserted into slot 104 of the scanner 100.

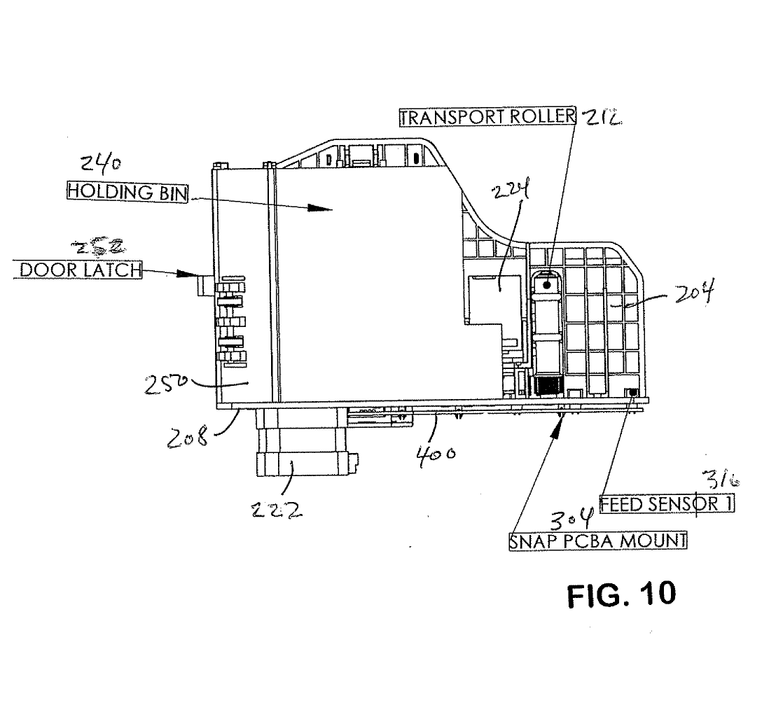

Transport rollers 212, 213 and 214 are disposed at spaced positions along path 210 to transport the check along path 210, as also shown in elevational view of FIG. 10. Disposed opposite each transport roller 212-214 is a pressure roller 216, 217 or 218; such as pressure rollers 216 disposed on the opposite side of path 210 from transport roller 212. Pressure rollers 216-218 are each biased against a respective transport roller 212-214 to keep the check in contact with its associated transport roller such that the transport rollers remain in contact with the check to move it along path 210. Transport rollers 212-214 are driven by a belt 220, which is in turn driven by drive source, such as drive motor 222.

Disposed along path 210 is a printer 224 for imprinting information on the check as it is transported along path 210. Printer 224 may print endorsement, cancellation, franking or other processing information on the check as it passes by the print head. In the embodiment illustrated in FIG. 2, the printer 224 is of the ink jet type, but may be any other suitable type. A MICR reader 226 is also disposed along path 210 to read the MICR information imprinted on the check as the check passes by reader 226. Preferably, a pair of contact image sensors (CIS) 228 and 229 is disposed along both sides of the path 210 to simultaneously obtain an image of each side of the entire check as the check passes by CIS 228 and 229.

Walls 204 and 206 which define scanning path 210 may each be unitary or may be in sections. For example, in the embodiment shown in FIG. 2, wall 204 is one piece. However, wall 206 is provided with a door 232 on which CIS 229 is attached. Door 232 has a snap latch 234 which enables door 232 to be opened, such as to clean or inspect the CIS 228 and/or 229. As will be further appreciated below, a diverter gate 236 is disposed along wall 206 which may be used to change the path 210 of the check during the scanning process. In the position shown in FIG. 2, diverter 236 is in the Scan-Return mode. In this mode, the check continues along path 210 into a holding bin 240. Drive of the transport rollers is then reversed, and the check is returned out of slot 210. While the check is being routed in the reverse direction along path 210, printer 224 can be printing additional information on the check, such as franking information. Also, while in this reverse drive mode, MICR reader 226 can again read the MICR information from the check and CIS 228-229 can obtain additional scanned images of the check. This MICR information and the scanned images can be compared to the MICR information and scanned images previously obtained while the check was scanned in the forward direction.

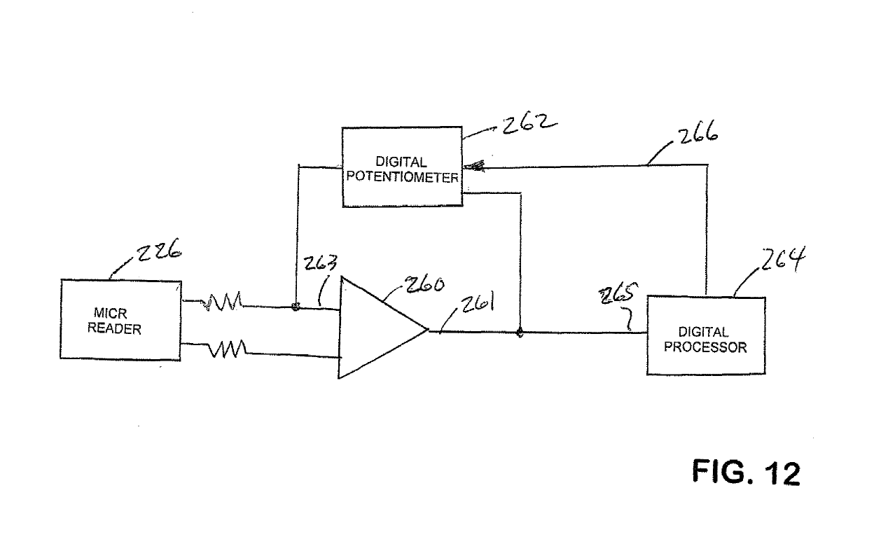

The MICR information is preferably obtained by redundant readings of the MICR information printed on the checks. For example and with reference to FIG. 12, the MICR reader 226 is typically connected to an analog amplifier 260 which is capable of adjustable gain. The amplitude of the MICR signal to the analog amplifier 260 varies greatly due to inconsistencies in the magnetic ink used to print the routing information on the checks. Additionally, the strength of the magnet used to charge the ink particles on the check varies from scanner to scanner. If the signal amplitude from the MICR reader 226 is too low, the analog amplifier 260 will not be able to generate a waveform that a software algorithm resident in a digital processor 264 will be able to decipher. On the other hand, if the signal amplitude is too high, the analog amplifier 260 will saturate and the waveform will be clipped at the extremes, which will create a flat top waveform. Such a flat top waveform also cannot be deciphered by the algorithm. Of course after the MICR information is read, it is too late to change the gain of the analog amplifier 260 if the signal is too low or too high. The amplitude of the MICR signal is determined by a digital processor 264 which receives the signal from an output terminal 261 of analog amplifier 260. Preferably, digital processor 264 has analog to digital conversion capability at its input terminal 265; but if not, an analog to digital converter may need to be disposed between the digital processor 264 and the analog amplifier 260 to provide a digital representation of the MICR signal to the digital processor 264.

The present invention determines the signal amplitude on the first pass of the check at the MICR reader 226. It then sets the gain of the analog amplifier 260 by means of a digital potentiometer 262 before the second pass of the check past the MICR reader 226 to optimize the signal received by the decoding algorithm resident in digital processor 264 on the second pass of the check. As shown in FIG. 12, digital potentiometer 262 is disposed in a feedback arrangement between output terminal 261 and input terminal 263 of analog amplifier 260. After the digital processor 264 determines the magnitude of the MICR signal, it sends a control signal via line 266 to the digital potentiometer. This control signal cause potentiometer 262 to vary its impedance, and therefore the gain of analog amplifier 262, to provide an improved MICR signal with characteristics that the algorithm resident in the digital processor 264 can accurately process. Thus, the MICR reading system is adaptive to the particular characteristics of the magnetic ink, and other MICR reading variables, to adjust the circuit gain for optimum MICR reading performance.

Preferably, the CIS 228-229 are of at least 300 dots per inch (DPI) capability such that the CIS 228-229 obtain a high resolution image of the check on the forward pass and an even higher resolution image of the check on the reverse pass, or vice versa. Alternately, the CIS 228 229 may obtain a grey scale image of the check on the forward pass and obtain a color image of the check on the reverse pass, or vice versa.

However, if diverter gate 236 is disposed in the pass-through position shown in FIG. 8, the check will be routed out of the back or end of the scanner 100. That is, the scanning of the check will occur in a single pass and the check will exit out of the scanner. Of course, in the pass-through mode, the MICR 226 may normally only obtain a single pass of information and the CIS 228-229 may normally only obtain a single image of the check. However, if the MICR information or check image is faulty, the drive system, including transport roller 214, may reverse direction before the check exits the scanner to take as many additional scans of the check as may be needed.

Wall 206 also preferably includes a door 250 for access to the holding bin 240. A door latch 252 may be used to unlock door 250, such that any jam of a check in the holding bin 240 may be removed. A portion 241 of holding bin 240 may not include wall 206. This is because holding bin portion 241 will have a wall provided by the top cover 102 when the cover is installed on the scanner 100. Thus, that portion of cover 102 adjacent to holding bin 240, and disposed along edge 209 of base 208, will act as an extension of wall 206 and will guide the check along that portion of the path 210.

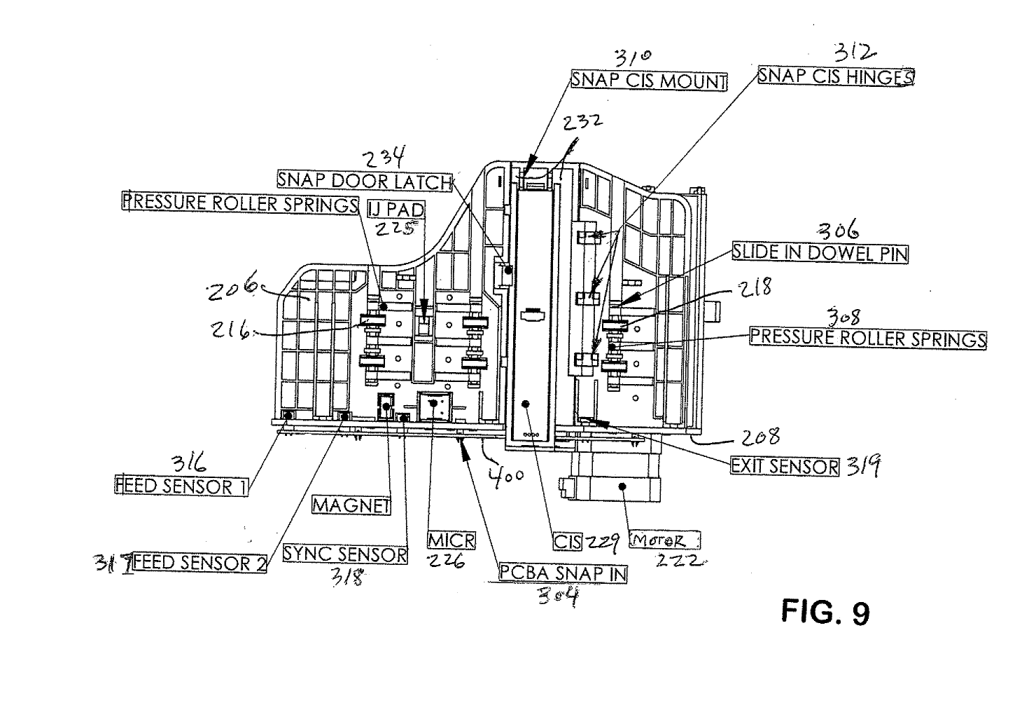

FIGS. 3-7 illustrate the movement of a check 300 through the scanner 100 when the scanner is in the scan and return mode, i.e., when the check will be scanned and returned back to the original point of entry of the scanner. In order to simplify the drawings, not all components are shown in all drawings. For example, belt 220 shown in FIG. 2 is not shown in FIGS. 3-7. With reference to FIG. 3, when check 300 is inserted into slot 104, sensors 316 and 317, shown in FIG. 9, senses its presence and initiates the drive system, including transport rollers 212-214. Thus, when the leading edge of check 300 comes into contact with transport roller 212, the movement of check 300 within scanner 100 becomes automatic.

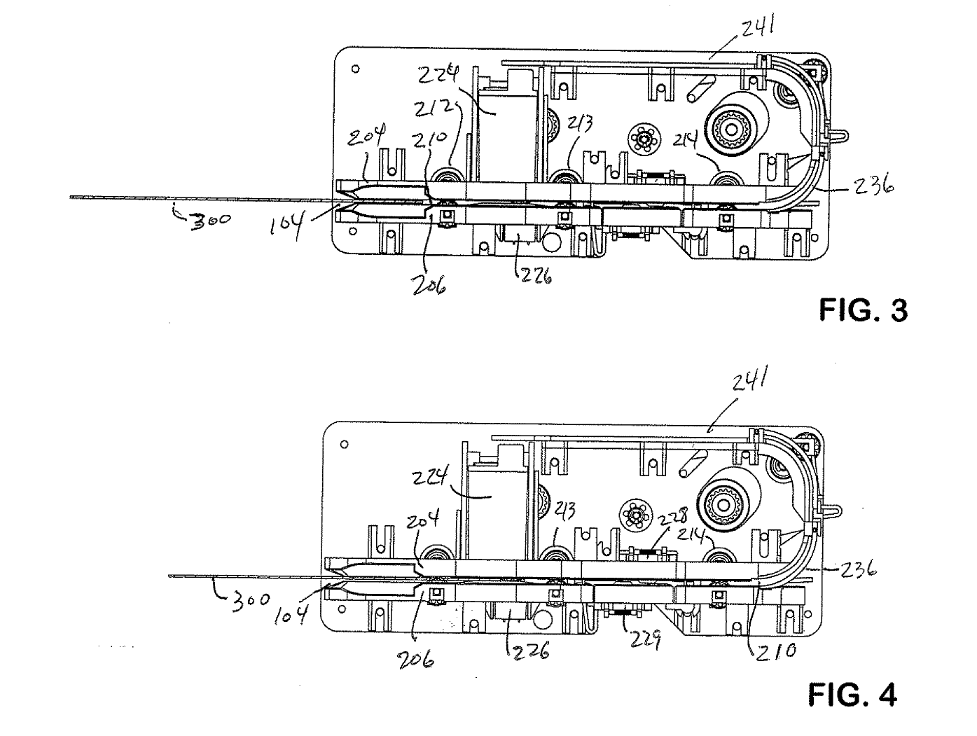

In FIG. 4, the leading edge of check 300 is moving along path 210 past ink jet printer 224 and MICR reader 226. Thus, printer 224 can begin printing any desired processing information on check 300 and MICR reader 226 is ready to begin reading the magnetic ink information printed on the check.

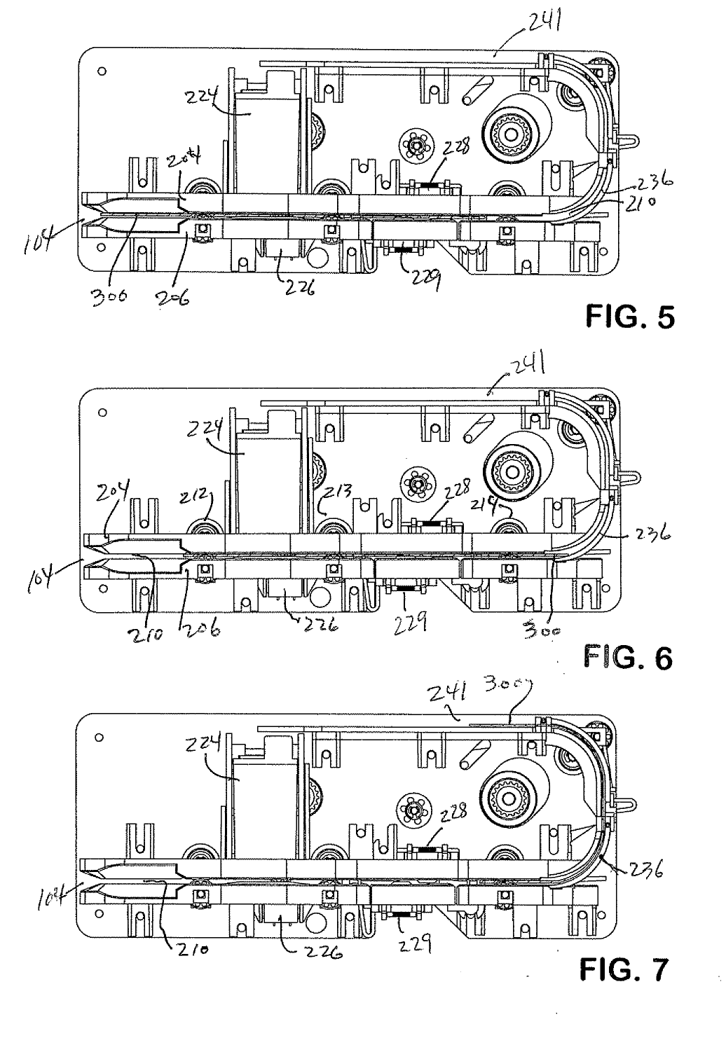

In FIG. 5, the leading edge of check 300 has moved past CIS sensors 228 and 229, and the trailing edge of check 300 is now in path 210. Thus, images of both sides of the check may be scanned simultaneously.

In FIG. 6, the leading edge of check 300 is now in contact with diverter gate 236, which directs check 300 along a curved portion of path 210.

In FIG. 7, check 300 is mostly in the holding bin 240 portion of path 210. A sensor 319, shown in FIG. 9, determines that check 300 has reached the end of its travel along path 210 and stops the drive system with transport roller 214 still in contact with the trailing edge of check 300. The drive system then reverses its direction of transport to rotate transport rollers 212-214 in an opposite direction, thereby moving check 300 back along path 210 toward opening port 104. The drive system continues in its reverse direction until sensor 316 and/or 317, shown in FIG. 9, senses that the check 300 has been removed or discharged from path 210. Thus, check 300 returns to, and exits from, the same port that it was inserted into for scanning. Also as shown in FIG. 9, a sync sensor 318 may be used to synchronize the position of the leading edge of the check 300 with respect to other components along the path 210. For example, the position of the MICR reader 226, the inkjet printer 224, the CIS scanners 228-229 and the exit sensor 319 may all be defined as being a fixed number of motor steps from the sync sensor 318. Thus, software which controls the drive system will know the position of the check 300 along the path 210 at any point in time.

FIG. 8 illustrates an alternative pass through movement of check 300 through scanner 100, instead of the scan and return movement of the check shown in FIGS. 3-7. In the pass-through mode, a collection tray 290 is pivoted out of a back wall 294 of the scanner 100. This pivotal movement of collection tray 290 closes diverter gate 236 to block off the curved portion of path 210 and the holding bin portion 241 of path 210. This positioning of diverter gate 236 provides a generally linear path 211 through the scanner 100 from the opening port 104 to the back or end of scanner 100. However, a portion 292 of path 211 defined by collection tray 209 may be curved or arcuate. In this mode of operation, after the check is printed by printer 224, read by MICR reader 226 and scanned by CIS scanners 228-229, the check 300 is normally discharged into the collection tray 290 at the back 294 of the scanner 100.

Sensor 319, shown in FIG. 9, can detect that the trailing edge of the check has past and that the check is in the process of being discharged at the back or end of the check scanner 100. Activation of the drive system can then be terminated. However, if the MICR information or check image is faulty, the drive system, including transport roller 214, may reverse direction before the check exits the scanner to take as many additional scans of the check as may be needed.

Preferably, there is a check holding bin 241, which may be in the form of an approximate semicircle as shown in the diagram for temporarily holding the check. When the check 300 reaches this holding bin 241, the drive system is then reversed and the check is driven in the reverse direction along the feed path 210 back toward the check input port 104. While the check is driven in the reverse direction, the print head 224 may print additional information on the check and the MICR read head 226 may again perform another MICR read on the check and the CIS scanning heads 228-229 may take another image of one or both sides of the check. These second reads and second scans may be digitally compared to the first reads and the first scans for verification purposes. Preferably, the present check scanner uses improved 300 DPI scan heads which can develop a color image of the check in addition to a grey scale image. Thus, the scan heads may produce a 200 DPI grey scale scan of the check when it is driven in the forward direction and produce a 300 DPI color scan of the check when it is driven in the reverse direction.

In accordance with another aspect of the present invention, most of the parts of the check scanner are supported by the walls 204 and 206 which define the path 210 of transport for the check 300 to be scanned. For example, and as seen in FIGS. 9-11, such wall-supported parts may include the CIS scanning heads 228-229, the MICR reader 226, the print head 224, the transport rollers 212-214, the pressure rollers 216-218, the CIS access door 232, the holding bin door 250 and diverter gate 236. Furthermore, the walls are configured to snap-in fit into the base plate 208 and to the circuit board 400 which is disposed below the base plate 208, such that the check scanner can be quickly and economically aligned and assembled. Preferably, many of these wall-supported parts also snap into place at their respective locations in the walls 204 and 206.

FIG. 9 illustrates an elevated view of the side of one of the walls 206. Wall 206 is shown assembled with pressure rollers 218 secured to wall 206 at three different locations by a slide in dowel pin 306. In addition, integrally formed pressure roller springs 308 bias the pressure rollers toward a corresponding transport roller 212, 213 or 214, as shown in FIG. 2 to engage check 300 there-between. CIS sensor head 229 is snapped into the CIS access door 232 and held in place by CIS snap mounts 310. CIS access door 232 forms a portion of wall 206 and is connected to wall 206 by a plurality of snap hinges 312 and a snap door latch 234. In a similar fashion, MICR reader 226 is secured to wall 206 and the ink jet printer 224 is secured to wall 204 opposite to ink jet pad 225.

As also seen in FIG. 9, wall 206 also includes a plurality of downwardly extending securing pegs 304, which extend through correspondingly located apertures in the base plate 208 to locate and secure the wall 206 relative to the base 208. Preferably, this plurality of securing pegs 304 each has a snap in end which extends through correspondingly located apertures in printed circuit board (PCB) 400 to locate and secure the PCB relative to the wall 206 and the base 208. In a similar fashion, and as seen in FIG. 10, inner wall 204 has similar securing pegs 304 to locate and secure wall 204 relative to base 208 and PCB 400.

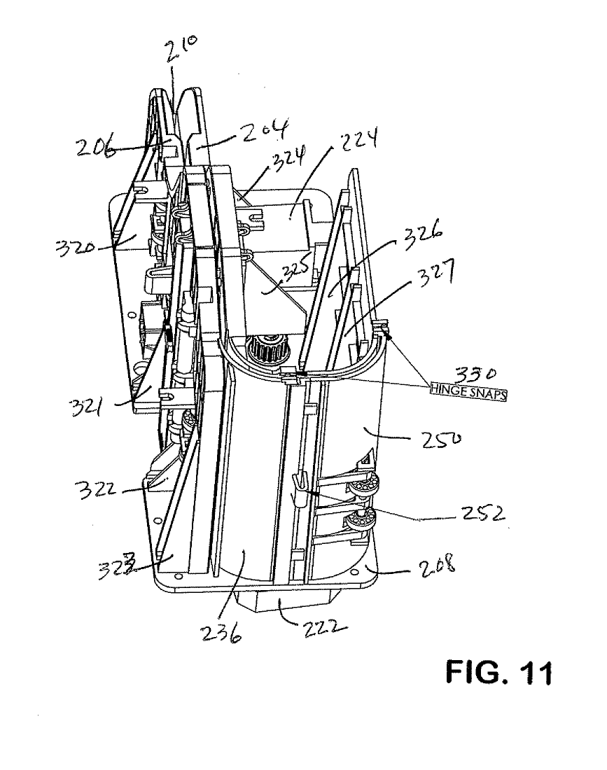

As seen in FIG. 11, for better lateral support of walls 204 and 206, both walls 204 and 206 may have laterally extending flanges 320-327. Of course, the apertures extending through base 208, through which the plurality of securing pegs 304 extend, determines the spacing between walls 204 and 206. This spacing determines the width of path 210 for routing of the check 300. A plurality of snap hinges 330 may be provided along the top edges of walls 204 and 206 to maintain this spacing for path 210 and to assist in providing rigidity along the upper portions of walls 204 and 206.

The walls 204 and 206 may be formed by any appropriate method, such as by plastic injection molding techniques. The walls 204 and 206 may be formed from any appropriate material, such as plastic materials. For example, walls 204 and 206 may be formed of 10% carbon filled polycarbonate/acrylonitrile-butadiene-styrene (PCABS).

While particular embodiments of the invention have been shown and described, it will be obvious to those skilled in the art that changes and modifications may be made therein without departing from the invention in its broader aspects.

1. A check scanner for scanning a check, said check scanner comprising:
a pair of parallel spaced-apart walls, said spaced-apart walls defining a path between the walls, said path having an inlet port in communication with the path for inserting the check into the scanner, and said path having an end,
a drive system for moving the check along the path in a forward direction,
means for determining when the check has reached the end of the path, and
said drive system reversing the direction of movement of the check when it is determined that the check has reached the end of the path to move the check along the path in a reverse direction to return the check to the inlet port.

2. The check scanner in accordance with claim 1, said means for determining when the check has reached the end of the path comprising a sensor.

3. The check scanner in accordance with claim 1, further comprising a printer disposed along said path, said printer printing information on the check when the check passes the printer in the forward direction and when the check passes the printer in the reverse direction.

4. The check scanner in accordance with claim 1, further comprising a pair of contact image sensors, each of said pair of contact image sensors disposed on opposite sides of said path, said pair of contact image sensors scanning both sides of the check when the check passes the pair of contact image sensors in the forward direction and again when the check passes the contact image sensor in the reverse direction thereby providing two scans of each side of the check.

5. The check scanner in accordance with claim 4, wherein said pair of contact image sensors has a resolution of at least 300 dots per inch (DPI) capability such that the contact image sensors obtain a high resolution image of the check on the forward pass and an even higher resolution image of the check on the reverse pass, or vice versa.

6. The check scanner in accordance with claim 4, wherein said pair of contact image sensors has color capability such that the contact image sensors obtain a grey scale image of the check on the forward pass and a color image of the check on the reverse pass, or vice versa.

7. The check scanner in accordance with claim 1, further comprising a magnetic ink character recognition reader disposed along said path, said magnetic ink character recognition reader reading information printed on the check when the check passes the magnetic ink character recognition reader in the forward direction and when the check passes the magnetic ink character recognition reader in the reverse direction.

8. The check scanner in accordance with claim 7, further comprising:
an analog amplifier for receiving a magnetic ink character information signal from the magnetic ink character recognition reader;
means for determining the magnitude of the magnetic ink character information signal from a first reading of the magnetic ink character information on the check; and
means for adjusting the gain of the analog amplifier in accordance with the determination of the magnitude of the magnetic ink character information signal before a second or redundant reading of the magnetic ink character information on the check.

9. The check scanner in accordance with claim 8, wherein the means for determining the magnitude of the magnetic ink character information signal comprises a digital processor.

10. The check scanner in accordance with claim 9, wherein the means for adjusting the gain of the analog amplifier comprises a digital potentiometer which is coupled to the analog amplifier and which receives a control signal from the digital processor for adjusting the gain of the analog amplifier for the next reading of the magnetic ink character information.

11. The check scanner in accordance with claim 1, further comprising a diverter gate disposed along the path, said diverter gate moveable between a first position in which the check is moved along the path in forward and reverse directions to return the check to the inlet port, and said diverter gate moveable to a second position in which the check is moved in the forward direction and the check is discharged into a collection tray at the end of the check scanner.

12. The check scanner in accordance with claim 11, wherein the path is generally linear when the diverter gate is in the second position.

13. The check scanner in accordance with claim 11, wherein the path is generally U-shaped when the diverter gate is in the first position, with one of the legs of the U-shape being truncated.

14. The check scanner in accordance with claim 13, wherein the truncated leg of the U-shaped path provides an internal holding bin for the check when the check reaches the end of the path.

15. The check scanner in accordance with claim 1, said scanner further comprising:
a top cover;
one of said spaced-apart walls terminating before the end of the path;
a portion of said top cover providing a wall for that portion of path which extends beyond the spaced-apart wall which terminates before the end of the path.

16. A method of scanning a check with a check scanner, said method comprising the steps of:
providing a pair of spaced-apart parallel walls with a path between said spaced-apart walls from an inlet port to an end,
moving the check along the path in a forward direction,
determining when the check has reached the end of the path, and
reversing the direction of movement of the check when it is determined that the check has reached the end of the path, and
moving the check along the path in a reverse direction to return the check to the inlet port.

17. The method of scanning a check with a check scanner in accordance with claim 16, said method comprising the additional step of:
determining when the check has reached the end of the path with a sensor.

18. The method of scanning a check with a check scanner in accordance with claim 16, said method comprising the additional steps of:
disposing a printer along said path,
printing information on the check when the check passes the printer in the forward direction, and
printing information on the check when the check passes the printer in the reverse direction.

19. The method of scanning a check with a check scanner in accordance with claim 16, said method comprising the additional steps of:
disposing a pair of contact image sensors on opposite sides of said path,
scanning both sides of the check with the pair of contact image sensors when the check passes in the forward direction, and
scanning both sides of the check with the pair of contact image sensors when the check passes in the reverse direction.

20. The method of scanning a check with a check scanner in accordance with claim 16, said method comprising the additional steps of:
providing the pair of color capable contact image sensors with a resolution of at least 300 dots per inch,
obtaining a grey scale image of both sides of the check when the check is scanned in one direction, and
obtaining a color image of both sides of the check when the check is scanned in the opposite direction.

21. The method of scanning a check with a check scanner in accordance with claim 16, said method comprising the additional steps of:
disposing a magnetic ink character recognition reader disposed along said path,
reading information printed on the check when the check passes the magnetic ink character recognition reader in the forward direction, and
reading information printed on the check when the check passes the magnetic ink character recognition reader in the reverse direction.

22. The method of scanning a check with a check scanner in accordance with claim 16, said method comprising the additional steps of:
disposing a diverter gate along the path,
positioning said diverter gate moveable to a first position in which the check is moved along the path in forward and reverse directions to return the check to the inlet port, and
positioning said diverter gate to a second position in which the check is moved in the forward direction and the check is discharged at the end of the check scanner.

23. The method of scanning a check with a check scanner in accordance with claim 22, said method comprising the additional step of:
providing a generally linear path when the diverter gate is in the second position.

24. The method of scanning a check with a check scanner in accordance with claim 22, said method comprising the additional step of:
providing a generally U-shaped path when the diverter gate is in the first position, with one of the legs of the U-shaped path being truncated.

25. The method of scanning a check with a check scanner in accordance with claim 22, said method comprising the additional step of:
providing an internal holding bin at the truncated leg of the U-shaped path for the check as the check reaches the end of the path.

26. The method of scanning a check with a check scanner in accordance with claim 16, said method comprising the additional step of:
providing a top cover for the check scanner;
terminating one of said spaced-apart walls before the end of the path; and
using a portion of said top cover to provide a wall for that portion of path which extends beyond the spaced apart wall which terminates before the end of the path.

27. A subassembly for a check scanner for scanning a check, said subassembly comprising:
a base, said base having a top side and a bottom side with a plurality of apertures extending between the top side and the bottom side,
a pair of spaced-apart walls, said spaced-apart walls defining a path between the walls for routing of said check in the check scanner, said spaced-apart walls having a plurality of downwardly extending securing pegs, said pair of spaced-apart walls assembled onto the top side of the base when plurality of downwardly extending securing pegs are inserted into the plurality of apertures in the base, and
a printed circuit board having a plurality of apertures arranged to receive at least some of the securing pegs of the pair of spaced-apart walls such that the printed circuit board is located and secured to the securing pegs adjacent to the bottom surface of the base.

28. A check scanner for scanning a check, said check scanner comprising:
a base plate,
a pair of spaced-apart parallel walls, said spaced-apart walls defining a path between the walls for routing of said check in the check scanner,
a pair of contact image sensor heads attached to the walls for obtaining images of the check,
a magnetic ink character recognition reader attached to one of the walls to read information from the check, and
a print head attached to one of the walls for printing information on the check,
whereby the pair of contact image sensor heads, and the magnetic ink character recognition reader are preassembled onto the pair of spaced-apart walls prior to assembling the pair of spaced apart walls onto the base.

29. The check scanner for scanning a check in accordance with claim 28, said check scanner further comprising:
a plurality of transport rollers preassembled onto at least one of the pair of spaced apart walls prior to the pair of spaced apart walls being assembled onto said base.

30. The check scanner for scanning a check in accordance with claim 28, said check scanner further comprising:
a plurality of pressure rollers preassembled onto at least one of the pair of spaced apart walls prior to the pair of spaced apart walls being assembled onto said base.

31. The check scanner for scanning a check in accordance with claim 28, said check scanner further comprising:
a contact image sensor door preassembled onto one of the pair of spaced apart walls prior to the pair of spaced apart walls being assembled onto said base.

32. The check scanner for scanning a check in accordance with claim 28, said check scanner further comprising:
a holding bin door preassembled onto one of the pair of spaced apart walls prior to the pair of spaced apart walls being assembled onto said base.

33. The check scanner for scanning a check in accordance with claim 28, said check scanner further comprising:
a diverter gate preassembled onto one of the pair of spaced apart walls prior to the pair of spaced apart walls being assembled onto said base.

34. A method of assembling a check scanner for scanning a check, said method comprising the steps of:
providing a base plate,
providing a pair of spaced-apart walls for routing of said check in the check scanner,
preassembling a pair of contact image sensor heads to the walls for obtaining images of the check,
preassembling a magnetic ink character recognition reader to one of the walls to read information from the check, and
assembling the pair of spaced apart walls onto the base after the contact image sensor heads and the magnetic ink character recognition reader have been preassembled onto the pair of spaced apart walls.

35. The check scanner for scanning a check in accordance with claim 34, said check scanner further comprising:
preassembling a plurality of transport rollers onto at least one of the pair of spaced apart walls prior to the pair of spaced apart walls being assembled onto said base.

36. The check scanner for scanning a check in accordance with claim 34, said check scanner further comprising:
preassembling a plurality of pressure rollers onto at least one of the pair of spaced apart walls prior to the pair of spaced apart walls being assembled onto said base.

37. The check scanner for scanning a check in accordance with claim 34, said check scanner further comprising:
preassembling a contact image sensor door onto one of the pair of spaced apart walls prior to the pair of spaced apart walls being assembled onto said base.

38. The check scanner for scanning a check in accordance with claim 34, said check scanner further comprising:
preassembling a holding bin door onto one of the pair of spaced apart walls prior to the pair of spaced apart walls being assembled onto said base.

39. The check scanner for scanning a check in accordance with claim 34, said check scanner further comprising:
preassembling a diverter gate onto one of the pair of spaced apart walls prior to the pair of spaced apart walls being assembled onto said base.

40. A method of reading magnetic character information imprinted on a check, said method comprising the steps of:
reading the magnetic character information on the check with a magnetic character information reader;
providing a magnetic ink character information signal from the magnetic character information reader to an analog amplifier;
determining the magnitude of the magnetic ink character information signal from a first reading of the magnetic ink character information on the check; and
adjusting the gain of the analog amplifier in accordance with the determination of the magnitude of the magnetic ink character information signal before further readings of the magnetic ink character information on the check.

41. The method of reading magnetic character information imprinted on a check in accordance with claim 40, said method comprising the further step of:
performing the step of determining the magnitude of the magnetic ink character information signal with a digital processor.

42. A method of reading magnetic character information imprinted on a check in accordance with claim 41, said method comprising the further steps of:
coupling a digital potentiometer to the analog amplifier for controlling the gain of the analog amplifier;
receiving a control signal at the digital potentiometer from the digital processor, said control signal related to the determination of the magnitude of the magnetic ink character information signal; and
adjusting the gain of the analog amplifier with the digital potentiometer for the next reading of the magnetic ink character information.
